(19) United States
(12) Patent Application Publication
(10) Pub. No.: US 2014/0133070 A1
(43) Pub. Date: May 15, 2014

(54) INVERTER DEVICE

(71) Applicant: FUJI ELECTRIC CO., LTD., Kanagawa (JP)

(72) Inventor: Tomokazu Yoshikawa, Yokkaichi-shi (JP)

(73) Assignee: FUJI ELECTRIC CO., LTD., Kawasaki-shi, (JP)

(21) Appl. No.: 14/124,102

(22) PCT Filed: Oct. 26, 2012
(86) PCT No.: PCT/JP2012/077770

§ 371 Date: Dec. 30, 2013

(30) Foreign Application Priority Data
Oct. 31, 2011 (JP) 2011-239733

(51) Int. Cl. H02B 1/015

(52) U.S. Cl. CPC H02B 1/015
USPC 361/624

(57) ABSTRACT

An inverter device includes an inverter stack, and a switchboard to insert the inverter stack from a front side to store. The inverter stack, as an output relay unit, linking three phase output terminals and output relay terminals forming the switchboard, alternatively, selects a first output relay unit wherein three phase output relay bars for directly outputting three phases of outputs from the output terminals to the output relay terminals and a fixing plate to fix the three phase output relay bars to the inverter stack are unitized through an insulating member, or a second output relay unit wherein a single-phase output relay bar for outputting three phase outputs from the output terminals as a single phase to the output relay terminals and a fixing plate to fix the single-phase output relay bar to the inverter stack are unitized through an insulating member.

### TECHNICAL FIELD

The present invention relates to an inverter device, and more specifically, relates to an inverter device including an inverter stack and a switchboard into which the inverter stack is caused to enter from the front and be housed.

### BACKGROUND ART

Conventionally, there has been known an inverter device including an inverter stack having casters on a bottom portion and a switchboard for inserting the inverter stack from the front to be housed (for example, refer to PTL 1).

### CITATION LIST Patent Literature

PTL 1: JP-A-7-123539

### SUMMARY OF INVENTION

### Technical Problem

Although not clearly indicated in PTL 1, the conventional inverter device is such that three phases of output terminal of the inverter stack and output relay terminals that configure the switchboard and to which are attached output wires connected to a load are linked by flat plate-like output relay bars. Further, when changing the output terminal configuration of the inverter device in response to customer demands, specification changes, or the like, the output relay bars linking the output terminals and output relay terminals are removed, and the output terminals and output relay terminals are linked with new output relay bars, after which, it is necessary to attach a fixing plate to the new output relay bars across an insulating member and fix the fixing plate to a predetermined region of the inverter stack, as a result of which, the work of changing the output terminal configuration is troublesome.

The invention, bearing in mind the heretofore described situation, has an object of providing an inverter device such that it is possible to easily carry out a change in the output terminal configuration linking the inverter stack and switchboard.

### Solution to Problem

In order to achieve the object, an inverter device according to the first embodiment of the invention relates to an inverter device including an inverter stack and a switchboard to insert the inverter stack from a front side to store. The inverter stack, as an output relay unit, linking three phases of output terminals of the inverter stack and output relay terminals forming the switchboard and attached with output wires connected to a load, alternatively selects from a first output relay unit or a second output relay unit. The first output relay unit is such that three phases of output relay bar capable of directly outputting three phases of output from the output terminals to the output relay terminals and a fixing plate to fix the three--phase output relay bar to the inverter stack are unitized through an insulating member. The second output relay unit is such that a single-phase output relay bar capable of outputting three phases of output from the output terminals, as a single phase, to the output relay terminals and a fixing plate for fixing the single-phase output relay bar to the inverter stack are unitized through an insulating member.

Also, an inverter device according to the second embodiment of the invention is such that, in the inverter device according to the first embodiment, the output relay terminals are provided to extend in an entering direction of the inverter stack in a housing bottom portion housing the inverter stack. The three phases of output relay bar configuring the first output relay unit include a first three-phase output relay bar and a second three-phase output relay bar. The first three-phase output relay bar extends in a vertical direction, and has an upper end portion capable of connecting to the output terminal. The second three-phase output relay bar has a base portion extending in a vertical direction and a leading end portion extending in the entering direction of the inverter stack from a lower end of the base portion, wherein the base portion is fastened to a lower end portion of the first three-phase output relay bar through a fastening member, and the leading end portion is capable of being fastened to the output relay terminal through a fastening member. The single-phase output relay bar configuring the second output relay unit includes a first single-phase output relay bar and a second single-phase output relay bar. The first single-phase output relay bar extends in a vertical direction, and having an upper end portion capable of connecting to the output terminal. The second single-phase output relay bar has a base portion extending in a vertical direction and a leading end portion extending in the entering direction of the inverter stack from a lower end of the base portion, wherein the base portion is fastened to a lower end portion of the first single-phase output relay bar through a fastening member and the leading end portion is capable of being fastened to the output relay terminal through a fastening member. The second three-phase output relay bar and second single-phase output relay bar having insertion holes to insert the fastening member have a diameter larger than the external diameter of the fastening member.

### Advantageous Effects of Invention

According to the invention, the inverter stack, as an output relay unit, linking three phases of output terminals of the inverter stack and output relay terminals forming the switchboard and attached with output wires connected to a load, alternatively, selects a first output relay unit wherein three phases of output relay bar capable of directly outputting three phases of output from output terminals to output relay terminals and a fixing plate for fixing the three phases of output relay bar to the inverter stack are unitized through an insulating member, or a second output relay unit wherein a single-phase output relay bar capable of outputting three phases of output from the output terminals as a single phase to the output relay terminals and a fixing plate for fixing the single-phase output relay bar to the inverter stack are unitized through an insulating member. Thus, it is possible to easily carry out a change in the output terminal configuration linking the inverter stack and switchboard.

### BRIEF DESCRIPTION OF DRAWINGS

FIG. 1 is a perspective view showing an inverter device, which is an embodiment of the invention.

FIG. 2 is a perspective view showing a state which an inverter stack configuring the inverter device shown in FIG. 1 is conveyed by the transport cart.

FIG. 3 is a perspective view showing a state in which the transport cart applied to the inverter device shown in FIG. 1 and FIG. 2 is viewed from a front side.

FIG. 4 is a perspective view showing a state in which the transport cart applied to the inverter device shown in FIG. 1 and FIG. 2 is viewed from a rear side.

FIG. 5 is a perspective view showing an enlargement of a condition in which the transport cart is brought into the proximity of a switchboard.

FIG. 6 is a perspective view showing a housing bottom portion of the switchboard shown in FIG. 1 and FIG. 2 in which the inverter stack is housed.

FIG. 7 is a perspective view showing an enlargement of a main portion of the housing bottom portion shown in FIG. 6.

FIG. 8 is an illustration showing a state in which the housing bottom portion of the switchboard shown in FIG. 6 is viewed from the side.

FIG. 9 is a perspective view showing the inverter stack configuring the inverter device shown in FIG. 1 and FIG. 2.

FIG. 10 is an illustration showing the configuration of the upper surface of an inverter main body.

FIG. 11 is a perspective view showing the configuration of a fan block.

FIG. 12 is an illustration illustrating a procedure for disposing the fan block in the inverter main body.

FIG. 13 is an illustration illustrating a procedure for disposing the fan block in the inverter main body.

FIG. 14, which illustrates a procedure for disposing the fan block in the inverter main body, is an enlarged sectional view showing a state in which a main portion is viewed from the front side.

FIG. 15, which illustrates a procedure for disposing the fan block in the inverter main body, is an enlarged sectional view showing a state in which a main portion is viewed from the side.

FIG. 16, which illustrates a procedure for disposing the fan block in the inverter main body, is an enlarged sectional view showing a state in which a main portion is viewed from the side.

FIG. 17 is a front view of the fan block disposed on an upper portion of the inverter main body.

FIG. 18 is an enlarged sectional side view of a main portion of the fan block disposed on an upper portion of the inverter main body.

FIG. 19 is an exploded perspective view of a main portion of the fan block disposed on an upper portion of the inverter main body.

FIG. 20 is an illustration for illustrating a procedure for removing the fan block from the inverter main body.

FIG. 21 is a front view for illustrating a procedure for removing the fan block from the inverter main body.

FIG. 22 is an illustration for illustrating a procedure for removing the fan block from the inverter main body.

FIG. 23 is a perspective view showing an input side connection condition of the inverter stack and switchboard.

FIG. 24 is an enlarged perspective view showing an enlargement of a main portion shown in FIG. 23.

FIG. 25 is a perspective view showing a release of the input side connection condition of the inverter stack and switchboard.

FIG. 26 is a perspective view showing an output side connection condition of the inverter stack and switchboard.

FIG. 27 is a perspective view showing a second output relay bar configuring an output relay bar shown in FIG. 26.

FIG. 28 is a side view showing a condition in which the second output relay bar configuring the output relay bar shown in FIG. 26 has been removed.

FIG. 29 is an illustration showing the configuration of a lower frame.

FIG. 30 is an illustration showing the configuration of a modification example of the lower frame.

FIG. 31 is a front view showing a first output relay unit.

FIG. 32 is a side view showing the first output relay unit.

FIG. 33 is a perspective view of the first output relay unit viewed from the front.

FIG. 34 is a perspective view of the first output relay unit viewed from behind.

FIG. 35 is a front view showing a second output relay unit.

FIG. 36 is a side view showing the second output relay unit.

FIG. 37 is a perspective view of the second output relay unit viewed from the front side.

FIG. 38 is a perspective view of the second output relay unit viewed from rear side.

FIG. 39 is an illustration showing a condition in which the first output relay unit shown in FIG. 31 to FIG. 34 is installed.

FIG. 40 is an illustration showing a condition in which the second output relay unit shown in FIG. 35 to FIG. 38 is installed.

FIG. 41 is a perspective view of an attachment member applicable to the first output relay unit shown in FIG. 31 to FIG. 34 viewed from the front.

FIG. 42 is a perspective view of the attachment member applicable to the first output relay unit shown in FIG. 31 to FIG. 34 viewed from behind.

FIG. 43 is an illustration showing a condition in which the attachment member shown in FIG. 41 and FIG. 42 is applied.

### DESCRIPTION OF EMBODIMENTS

Hereafter, referring to the attached drawings, a detailed description will be given of a preferred embodiment of an inverter device according to the invention.

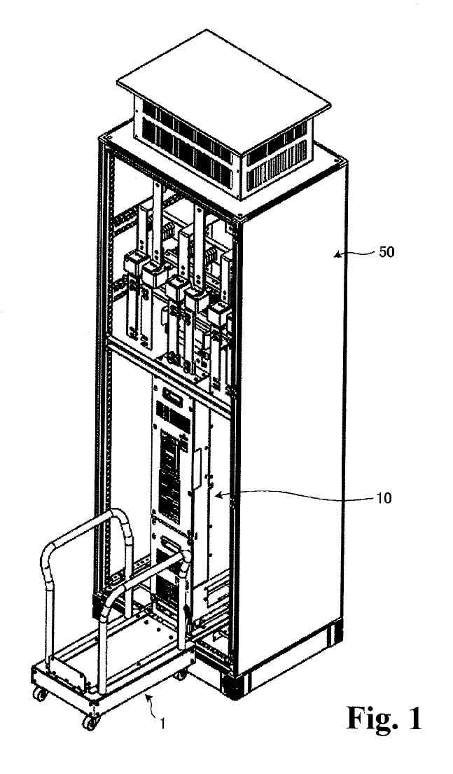

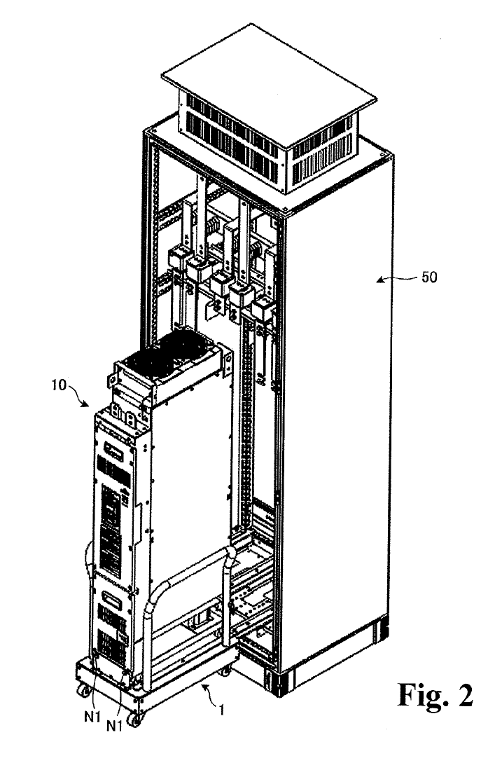

FIG. 1 is a perspective view showing an inverter device, which is an embodiment of the invention. The inverter device illustrated here is configured to include an inverter stack 10 and a switchboard 50. The inverter stack 10 includes an inverter circuit in the interior thereof, is transported by a transport cart 1, as shown in FIG. 2, and installed in the target switchboard 50.

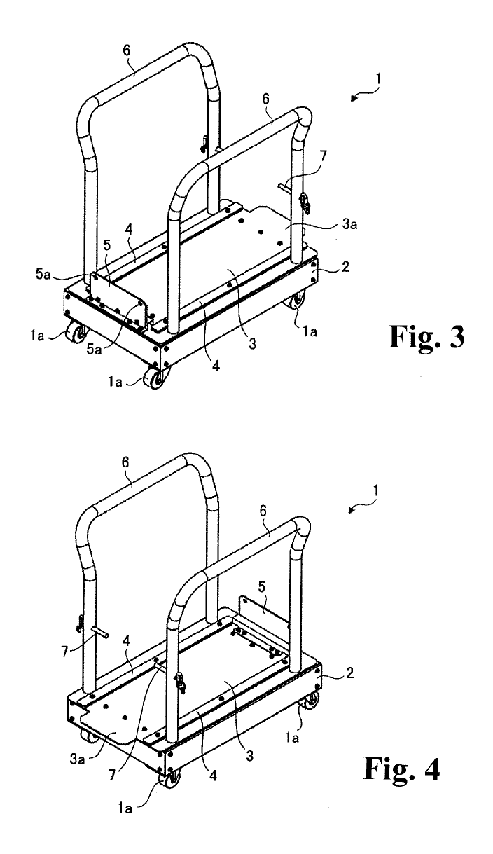

FIG. 3 and FIG. 4 each show the transport cart 1 applied to the inverter device shown in FIG. 1 and FIG. 2, wherein FIG. 3 is a perspective view showing a state in which the transport cart 1 is viewed from the front side, while FIG. 4 is a perspective view showing a state in which the transport cart 1 is viewed from rear side.

As shown in FIG. 3 and FIG. 4, the transport cart 1 is configured of a support surface 3, rail guides (guide members) 4, a fixing plate (fixing and supporting member) 5, and gripping portions 6 provided on a base 2 including a plurality of (for example, four) cart casters 1a.

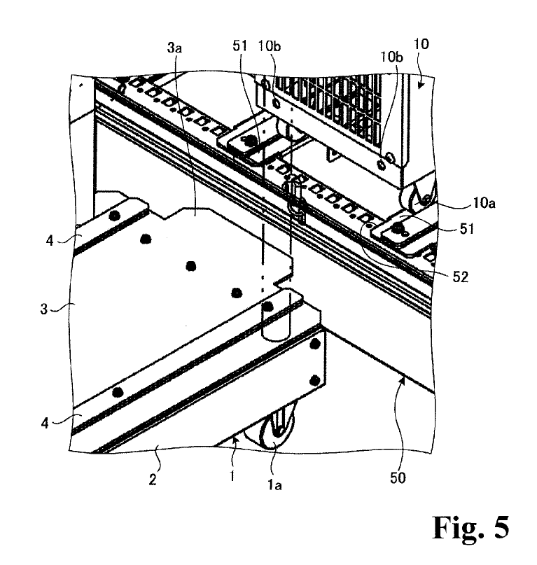

The support surface 3 is configured of a steel plate, or the like, on the upper surface of the base 2, and is a surface on which casters 10a provided on a bottom portion of the inverter stack 10 can roll. The support surface 3 supports the inverter stack 10 in a condition in which the inverter stack 10 is mounted. As shown in FIG. 5, the support surface 3 has a height level the same as that of two mounting surfaces 51 of the inverter stack 10 in the switchboard 50, that is, surfaces on which the casters 10a of the inverter stack 10 can roll.

A protruding portion 3a is provided on this kind of support surface 3. The protruding portion 3a is a plate-like portion formed so as to protrude backward from a rear edge portion of the support surface 3. The size of the left-to-right width of the protruding portion 3a matches the distance between the two mounting surfaces 51 in the switchboard 50, and when bringing the transport cart 1 into proximity from the front, positioning in a horizontal direction is carried out by the protruding portion 3a entering an entrance portion 52 of the switchboard 50 formed between the mounting surfaces 51, as shown in FIG. 5.

The rail guides 4 are elongated plate-like bodies extending in a longitudinal direction on both left and right ends of the support surface 3. The rail guides 4 are fixed to the support surface 3 with screws, or the like. The rail guides 4 of this kind guide the rolling of the casters 10a of the inverter stack 10 when the inverter stack 10 supported in amounted condition by the support surface 3 is moved toward the switchboard 50, and restrict deviation in a horizontal direction of the inverter stack 10.

The fixing plate 5 is a plate-like body provided so as to stand upright from the base 2 on the front side of the support surface 3. A plurality of (for example, two) screw holes 5a is formed in the fixing plate 5. When the inverter stack 10 is supported in amounted condition by the support surface 3, the screw holes 5a are provided corresponding one each to screw holes 10b formed in a lower front surface of the inverter stack 10. Because of this, when the inverter stack 10 is supported by the support surface 3, screws N1 are inserted from the front through both the screw holes 5a of the fixing plate 5 and the screw holes 10b of the inverter stack 10, and the fixing plate 5 is fastened to the inverter stack 10 by tightening the screws N1 by rotating them around the axes thereof.

That is, the fixing plate 5 fixes and supports the Inverter stack 10 by being fastened to the inverter stack 10 supported by the support surface 3 via fastening members such as the screws N1.

The gripping portions 6 are formed so as to forma horizontal pair on the base 2. The gripping portions 6 are configured by appropriately bending pipes, which are elongated rod-like bodies, and connecting both ends of each pipe to the base 2 by welding or the like, and are gripped by the user, that is, the conveyor of the inverter stack 10. References 7 in FIG. 3 and FIG. 4 are stoppers, and are provided on the gripping portions 6.

The inverter stack 10 mounted on and supported by the support surface 3 of this kind of transport cart 1 is conveyed to the front of the switchboard 50 in which the inverter stack 10 is to be installed, as shown in FIG. 2, and positioning is subsequently carried out by the transport cart 1 being brought into proximity with the switchboard 50, and the protruding portion 3a being entered into the predetermined entrance portion 52 of the switchboard 50. Then, the screws N1 inserted through the screw holes 5b and 10b of the fixing plate 5 and inverter stack 10 are removed, thus releasing the fastening of the fixing plate 5 and inverter stack 10, and the inverter stack 10 can be housed in the switchboard 50 as shown in FIG. 1 by the inverter stack 10 being moved and entered from the front of the switchboard 50.

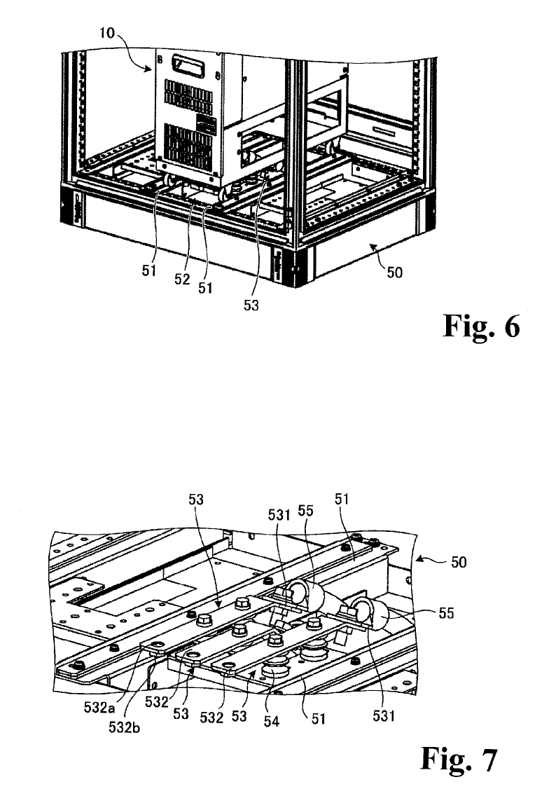

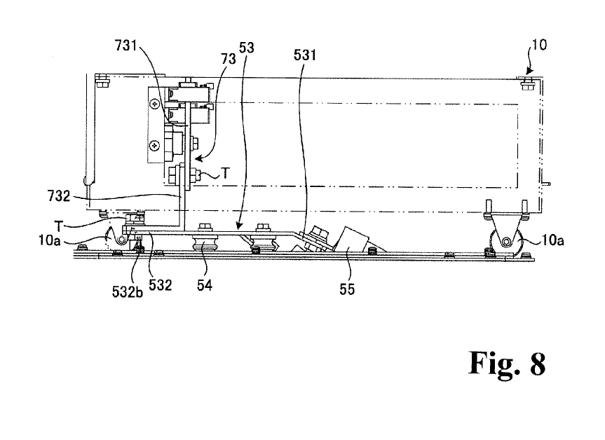

FIG. 6 is a perspective view showing a housing bottom portion of the switchboard 50 shown in FIG. 1 and FIG. 2 in which the inverter stack 10 is housed, FIG. 7 is a perspective view showing an enlargement of a main portion of the housing bottom portion shown in FIG. 6, and FIG. 8 is an illustration showing a state in which the housing bottom portion of the switchboard 50 shown in FIG. 6 is viewed from the side. As shown in FIG. 6 to FIG. 8, the switchboard 50 includes an output relay terminal 53.

A plurality of (for example, three) the output relay terminals 53 being provided, a U-phase output relay terminal 53, a V-phase output relay terminal 53, and a W-phase output relay terminal 53 are provided extending in the inverter stack 10 entry direction, that is, the longitudinal direction, and are provided in the housing bottom portion of the switchboard 50 so as to be aligned in parallel across insulators 54. A rear surface end portion 531 of each of the output relay terminals 53 bends downward, and an output wire 55 connected to a load such as, for example, a motor, is attached to each rear surface end portion 531. Also, a through hole 532a is formed in a front surface end portion 532 of each of the output relay terminals 53, and a nut 532b is fixed and supported on the lower surface corresponding to the relevant through hole 532a.

The output relay terminals 53 are positioned lower than a bottom portion of the inverter stack 10 to be housed, or more specifically, the output relay terminals 53 are in a position at a height level lower than that of the casters 10a of the inverter stack 10.

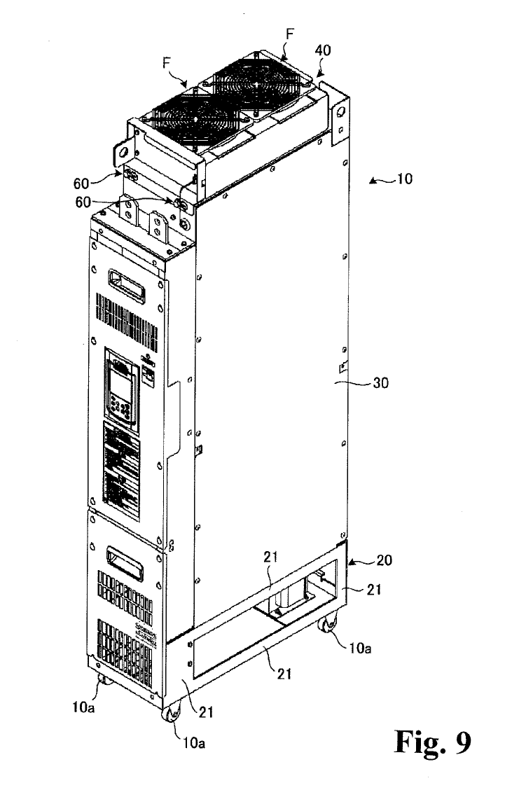

FIG. 9 is a perspective view showing the inverter stack 10 configuring the inverter device shown in FIG. 1 and FIG. 2. The inverter stack 10 is configured to include a lower frame 20, an inverter main body 30, and a fan block 40. The lower frame 20 configures the bottom portion of the inverter stack 10, and has the heretofore described casters 10a. Although a detailed description will be given hereafter, the lower frame 20 is formed of a plurality of frame members 21 linked by screwing, or the like, so as to form the sides of a cuboid.

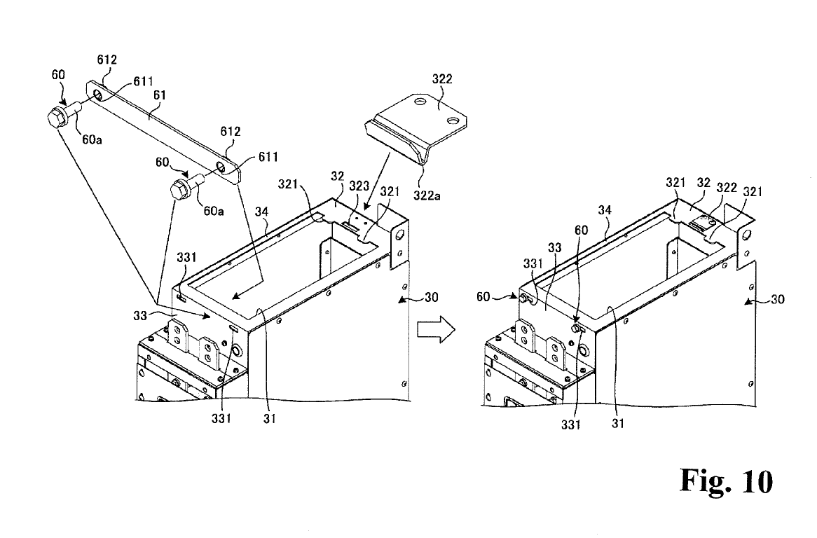

The inverter main body 30 is a housing incorporating in the interior thereof various circuits, such as an inverter circuit. An aperture 31 is formed in the upper surface of the inverter main body 30, as shown in FIG. 10. Two protruding pieces 321 protruding frontward are formed on a rear edge portion 32 of the upper surface of the inverter main body 30 in which this kind of aperture 31 is formed. Also, a plate spring member 322 is fixed by fastening with screws, or the like, to the rear edge portion 32. A leading end portion 322a of the plate spring member 322 is of a form bent downward, and the leading end portion 322a enters a rectangular through hole 323 formed in the rear edge portion 32 from above.

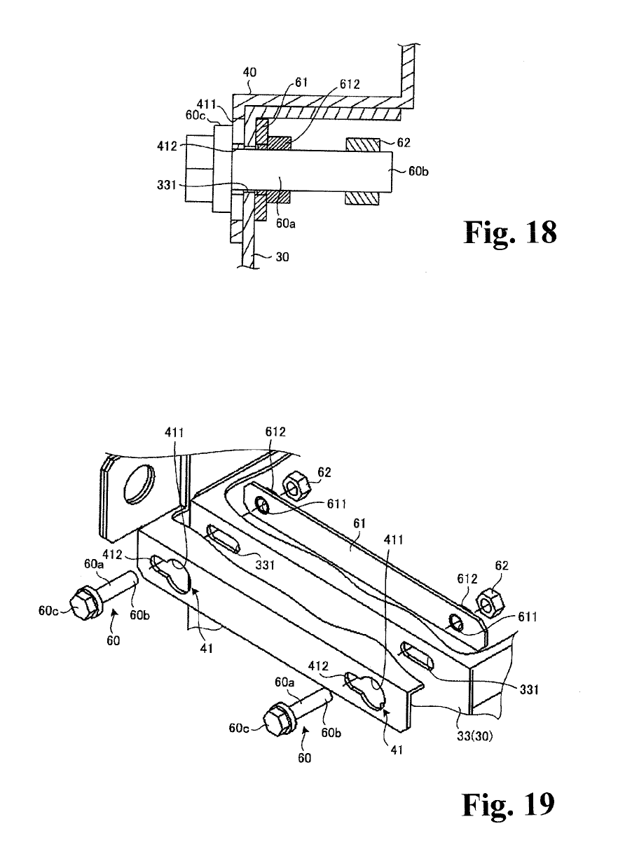

Also, the inverter main body 30 is such that two slots 331 whose horizontal direction is the longitudinal direction are formed in an upper front surface 33 connected to the upper surface in which the aperture 31 is formed. Body portions 60a of bolt members 60 are passed through the slots 331 from the front, wherein the body portions 60a passing through the slots 331 are screwed into nuts 612 fixed to a plate member 61 sc as to pass through through holes 611, larger than the slots 331, formed in the plate member 61, which is an elongated plate-like body. Also, although not shown in FIG. 10, stopper nuts 62 are fixed to leading end portions 60b of the bolt members 60 (refer to FIG. 18 and FIG. 19).

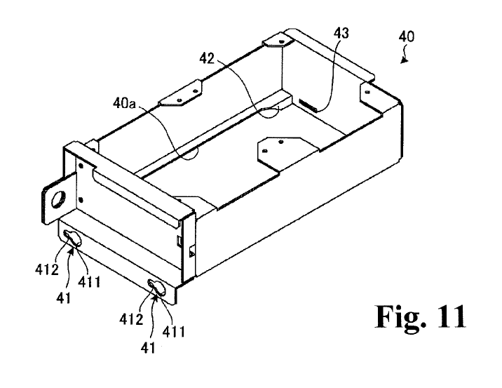

The fan block 40 is disposed on an upper portion of the inverter main body 30, and is of a box form in the interior of which are housed a plurality of fans F for sending air to the inverter main body 30. The fan block 40 forms a cuboid form of which the upper surface and lower surface are opened, as shown in FIG. 11.

An engagement hole 41, a flange 42, and a latch hole 43 are formed in this kind of fan block 40. A plurality of (for example, two) engagement holes 41 is formed in a lower front surface of the fan block 40, that is, in the front surface of a portion extending downward from an extended end portion extending forward from a lower end portion of the front surface of the fan block 40. The engagement holes 41 are of a keyhole shape wherein an attachment hole portion 411, of a diameter larger than that of a head portion 60c of the bolt member 60, and a clamping hole portion 412, of a diameter smaller than that of the head portion 60c of the bolt member 60, are formed so as to be continuous.

The flange 42 is formed so as to extend downward at the rear side of a horizontal lower side edge portion forming a lower surface aperture 40a of the fan block 40. The latch hole 43 is formed in the rear surface of the fan block 40, and is of a size such as to allow the protruding piece 321 to be inserted through.

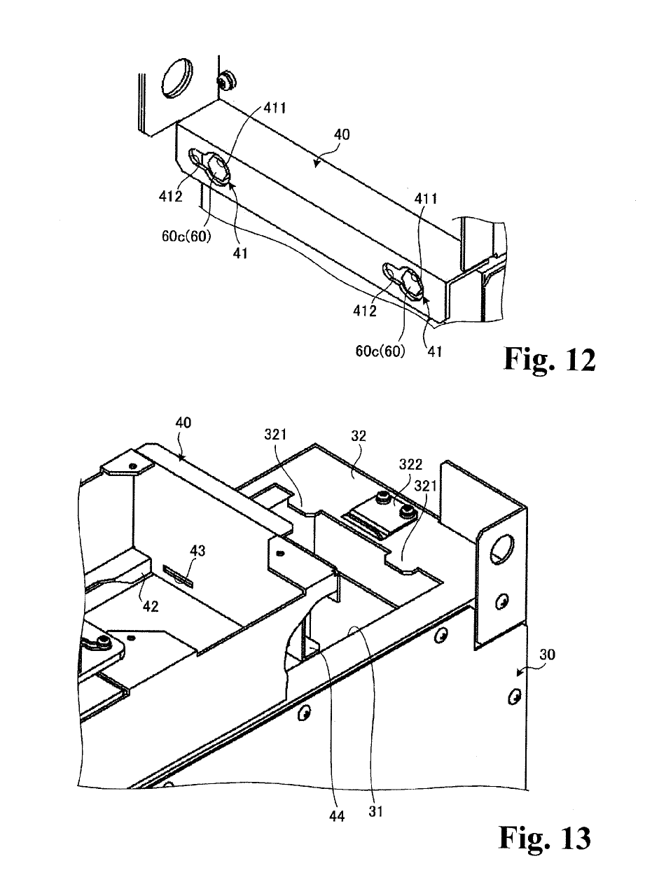

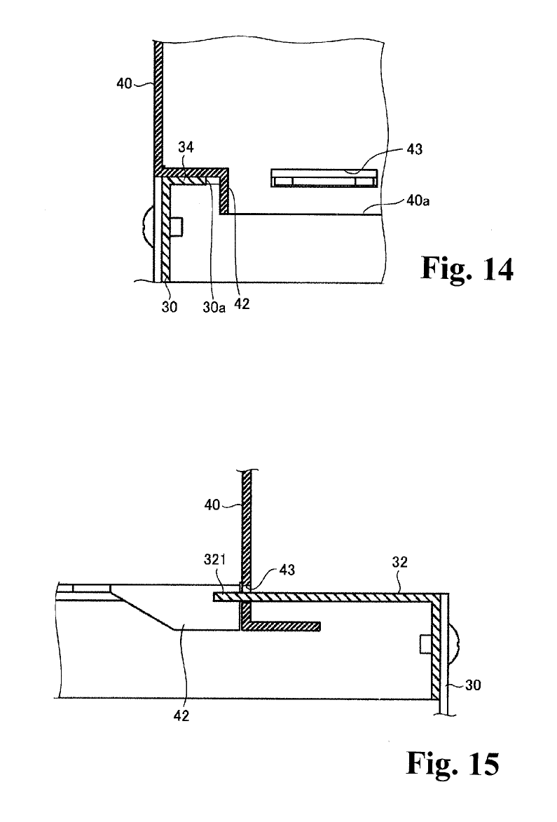

This kind of fan block 40 is engaged with and disposed on the inverter main body 30 in the following way. The fan block 40 is slid over the upper surface of the inverter main body 30 from the front toward the rear so that the head portions 60c of the bolt members 60 relatively pass through the attachment hole portions 411 of the engagement holes 41, as shown in FIG. 12. At this time, the flange 42 of the fan block 40 is positioned inward of an upper side edge portion 34 of the upper surface forming the aperture 31 of the inverter main body 30, as shown in FIG. 13 and FIG. 14, preventing the sliding fan block 40 from deviating more than necessary in a horizontal direction.

Then, the protruding piece 321 of the inverter main body 30 is relatively inserted through the latch hole 43 of the fan block 40, as shown in FIG. 15, and the rear side of the fan block 40 engages with the inverter main body 30 by the leading end portion 322a of the plate spring member 322 holding down a rear extending portion 44 extending backward from a lower end portion of the rear surface of the fan block 40 with its own elastic restoring force, as shown in FIG. 16.

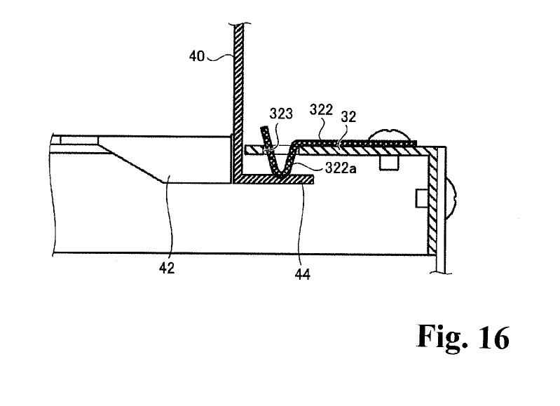

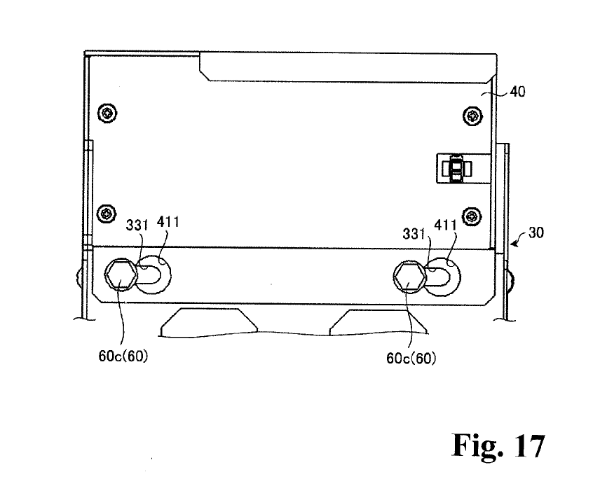

Subsequently, the front side of the fan block 40 engages with the inverter main body 30, as shown in FIG. 17 to FIG. 19, by the bolt members 60 being displaced in a horizontal direction so that the head portions 60c thereof move from the attachment hole portions 411 to the clamping hole portions 412, and the bolt members 60 being tightened. By so doing, it is possible to dispose the fan block 40 on the upper surface of the inverter main body 30.

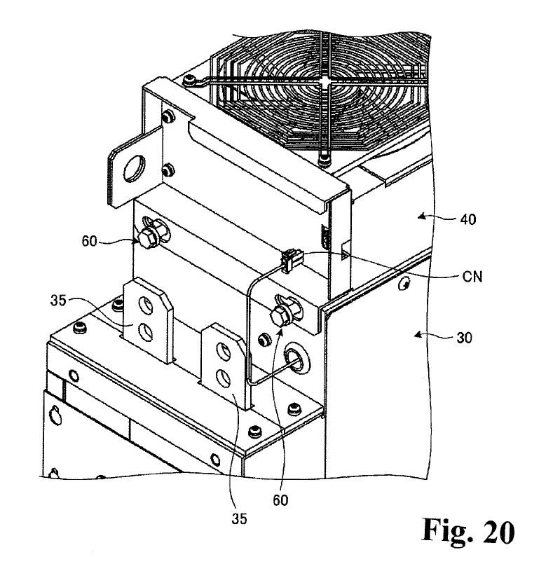

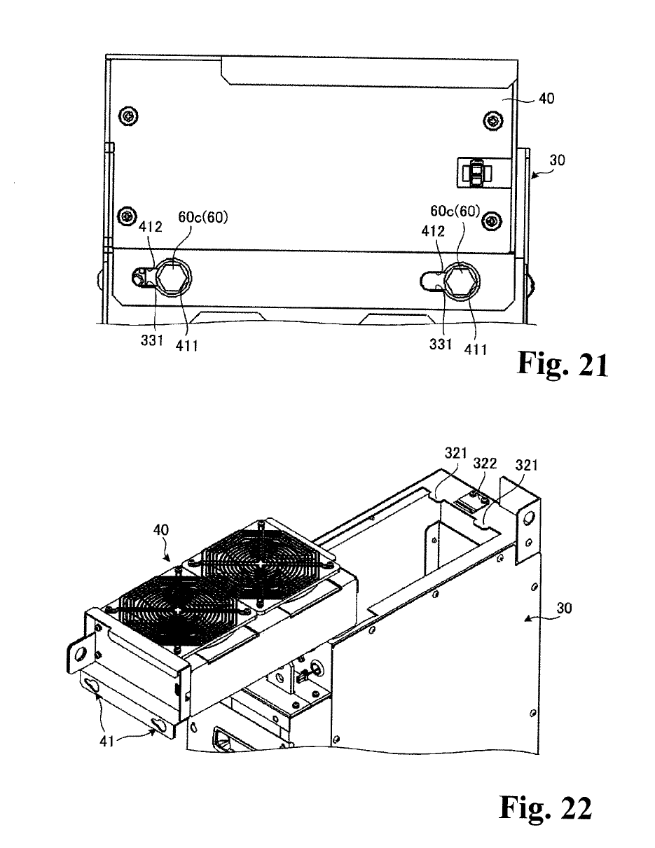

Meanwhile, this kind of fan block 40 is removed from the inverter main body 30 in the following way. A connector CN attached to the fan block 40 is removed, thereby releasing the tightening force of the bolt members 60, as shown in FIG. 20. Subsequently, the bolt members 60 are displaced in a horizontal direction so that the head portions 60c thereof move from the clamping hole portions 412 to the attachment hole portions 411, as shown in FIG. 21. Then, the fan block 40 is removed from the inverter main body 30 by the fan block 40 being pulled out to the front side, as shown in FIG. 22.

That is, between the inverter main body 30 and fan block 40, the bolt members 60, engagement holes 41, protruding pieces 321, latch hole 43, and plate spring member 322 configure engagement means that causes the fan block 40 to engage with the inverter main body 30.

In particular, the bolt members 60 and engagement holes 41 are such that, when the bolt members are tightened in a condition wherein the body portions 60a of the bolt members 60 are passed through the clamping hole portions 412 of the engagement holes 41, the fan block 40 is engaged with the inverter main body 30, while when the body portions 60a are passed through the attachment hole portions 411 of the engagement holes 41 by the tightening force of the bolt members 60 being released and the bolt members 60 being slid in a horizontal direction relative to the engagement holes 41, the fan block 40 is allowed to be disengaged from the inverter main body 30 by being pulled out to the front side.

The inverter stack 10 having this kind of configuration is housed and installed in the switchboard 50 in the following way.

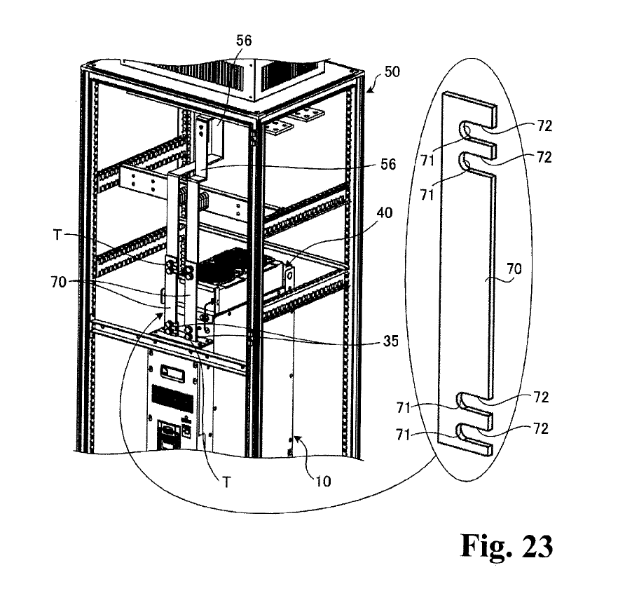

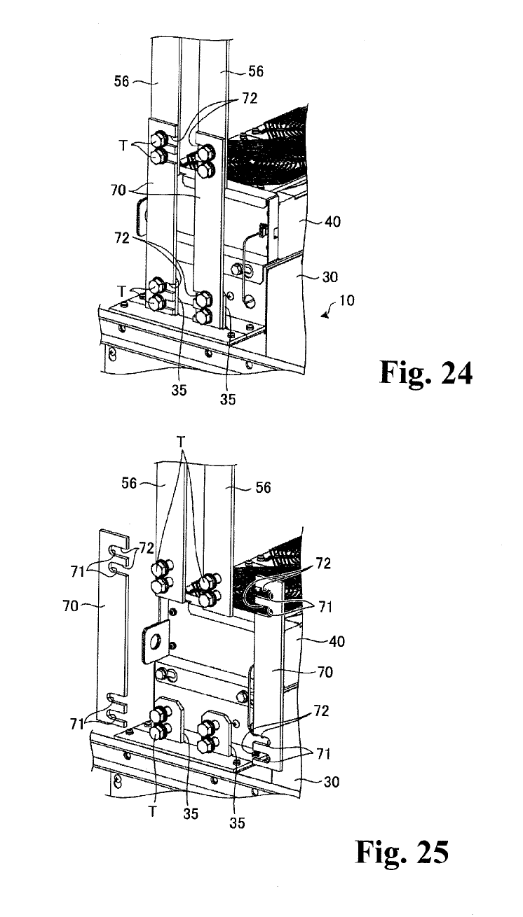

FIG. 23 is a perspective view showing an input side connection condition of the inverter stack 10 and switchboard 50, while FIG. 24 is an enlarged perspective view showing an enlargement of a main portion shown in FIG. 23. As shown in FIG. 23 and FIG. 24, the inverter stack 10 is such that two input terminals 35 provided on the inverter main body 30 are each linked via an input relay bar 70 to an input side terminal 56 of the switchboard 50.

The input relay bar 70 is a plate-like member that links the input side terminal 56 and input terminal 35 as heretofore described by an upper end portion thereof being fastened via fastening members T to the corresponding input side terminal 56 of the switchboard 50 and a lower end portion thereof being fastened via fastening members T to the corresponding input terminal 35 of the inverter stack 10.

Further, in each input relay bar 70, cutouts 72 are formed communicating with the same side portion (the right side portion or left side portion) in hole portions 71 through which bolts, which are the fastening members T, pass.

As the cutouts 72 are formed in the hole portions 71 of the input relay bar 70 in this way, it is possible to disengage the input relay bar 70, without removing the fastening members T, by releasing the tightening force of the fastening members T, as shown in FIG. 25.

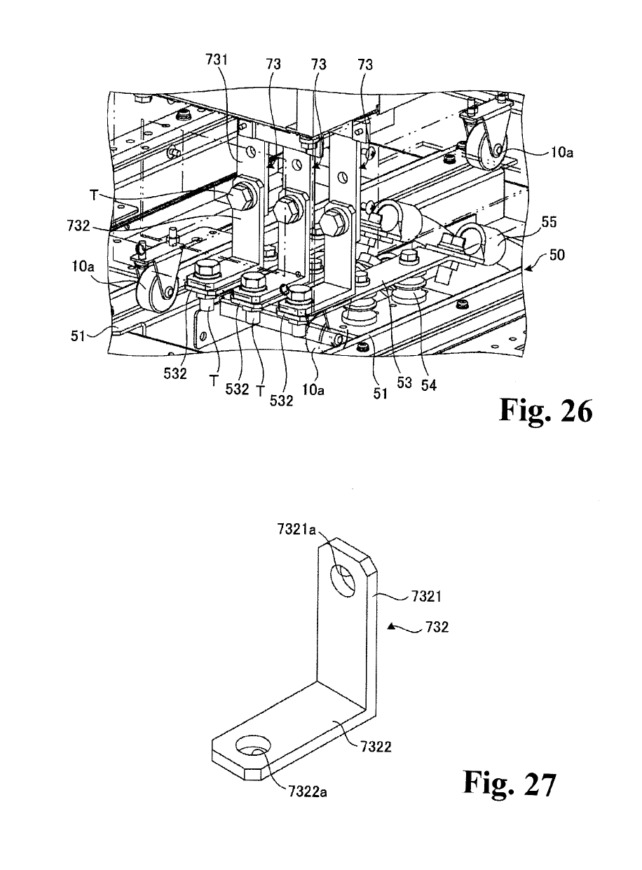

FIG. 26 is a perspective view showing an output side connection condition of the inverter stack 10 and switchboard 50. As shown in FIG. 26 and also in the heretofore described FIG. 8, three unshown output terminals provided on the inverter main body 30 are each linked via an output relay bar 73 to the front surface end portion 532 of the output relay terminal 53 of the switchboard 50. Herein, three of the output relay bars 73 being provided, there is one that links a U-phase output terminal and the U-phase output relay terminal 53, one that links a V-phase output terminal and the V-phase output relay terminal 53, and one that links a W-phase output terminal and the W-phase output relay terminal 53.

Each of this kind of output relay terminal 73 has the same configuration, and includes a first output relay bar 731 and second output relay bar 732. The first output relay bar 731 extends in a vertical direction, and an upper end portion thereof is linked to the corresponding output terminal.

The second output relay bar 732 has an L-shaped longitudinal section form, and more specifically, has a base portion 7321 and leading end portion 7322, as shown in FIG. 27. The base portion 7321 is a region extending in a vertical direction and protruding downward from the bottom portion of the inverter stack 10, wherein an upper end portion thereof is fastened via a fastening member T to a lower end portion of the first output relay bar 731. The leading end portion 7322 is a region extending forward from a lower end portion of the base portion 7321, and is fastened via a fastening member T to the front surface end portion 532 of the corresponding output relay terminal 53. That is, the output relay terminal 53 provided in the switchboard 50 is such that the output wire 55 connected to a load such as a motor is attached to the rear surface end portion 531, and the front surface end portion 532 is linked to the output terminal of the inverter stack 10 and fastened via a fastening member T to the output relay bar 73 protruding downward from the bottom portion of the inverter stack 10.

An insertion hole 7321a in the base portion 7321 through which the fastening member T is inserted, and an insertion hole 7322a in the leading end portion 7322 through which the fastening member T is inserted, are formed in this kind of second output relay bar 732 so as to have a diameter larger than the outer diameter of the fastening member T.

Because of this, it is possible to absorb dimensional tolerance in a horizontal direction and vertical direction with the insertion hole 7321a of the base portion 7321, and possible to absorb dimensional tolerance in a horizontal direction and longitudinal direction with the insertion hole 7322a of the leading end portion 7322.

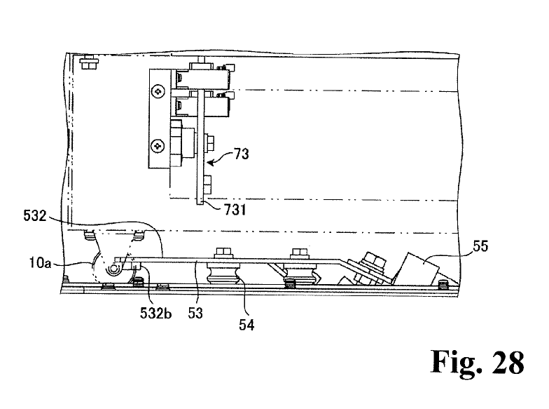

Also, the output relay bar 73 is such that it is possible to implement the setting up of a single inverter that inspects the drive of the inverter stack 10 by removing the second output relay bar 732 from both the first output relay bar 731 and the corresponding output relay terminal 53, as shown in FIG. 28.

As the output relay bar 73 is provided so as to pass through the lower frame 20 of the inverter stack 10, the lower frame 20 is such that the frame members 21 configuring one side of a four-sided frame through which the output relay bar 73 passes, that is, the frame member 21 configuring a front upper side and the frame member 21 configuring a front lower side, are formed of a non-magnetic body such as, for example, stainless steel, while the other frame members 21 are formed of sheet-metal, or the like, as shown in FIG. 29.

By the frame members 21 configuring one side of the four-sided frame through which the output relay bar 73 passes being formed of a non-magnetic body in this way, it is possible to control the occurrence of an overcurrent.

In FIG. 29, the frame member 21 configuring the front upper side and the frame member 21 configuring the front lower side are formed of a non-magnetic body as one side of the four-sided frame through which the output relay bar 73 passes, but the lower frame 20 of the embodiment is such that a front portion 23 of the lower frame 20, formed of longitudinal frame members 22 configuring a horizontal pair of front longitudinal sides linking the frame member 21 configuring the front upper side and the frame member 21 configuring the front lower side, may be formed of a non-magnetic body such as, for example, stainless steel, as shown in FIG. 30.

With this kind of configuration too, by the frame members 21 configuring one side of the four-sided frame through which the output relay bar 73 passes being formed of a non-magnetic body, it is possible to control the occurrence of an overcurrent.

The heretofore described inverter device is such that the output relay bars 73 are an output relay unit, wherein one linking the U-phase output terminal and U-phase output relay terminal 53, one linking the V-phase output terminal and V-phase output relay terminal 53, and one linking the W-phase output terminal and W-phase output relay terminal 53 are shown, but in the embodiment, an output relay unit alternatively selected from a first output relay unit 80 and second output relay unit 90 may be used as the output relay unit instead of the output relay bar 73.

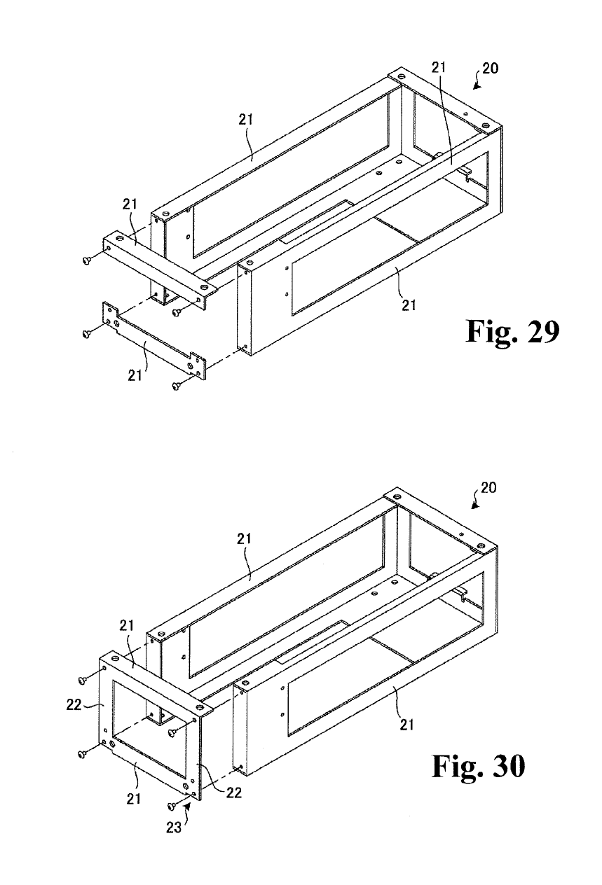

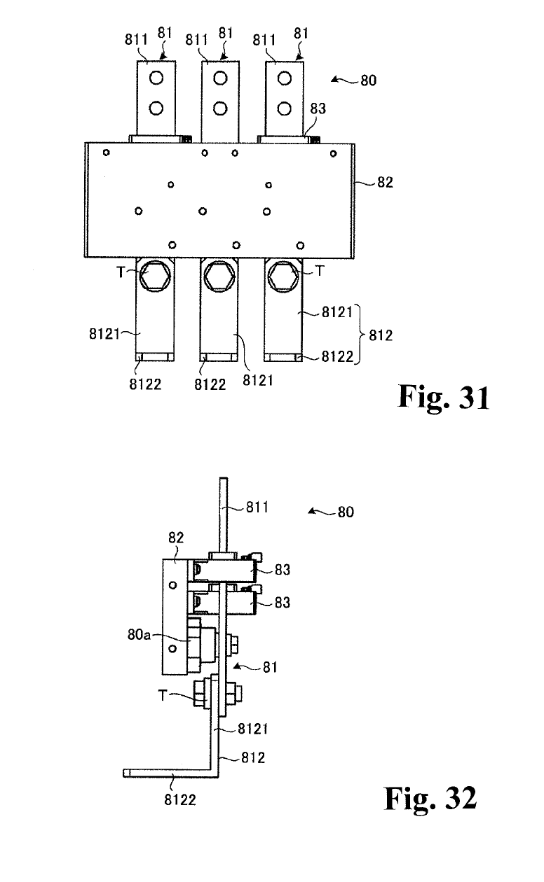

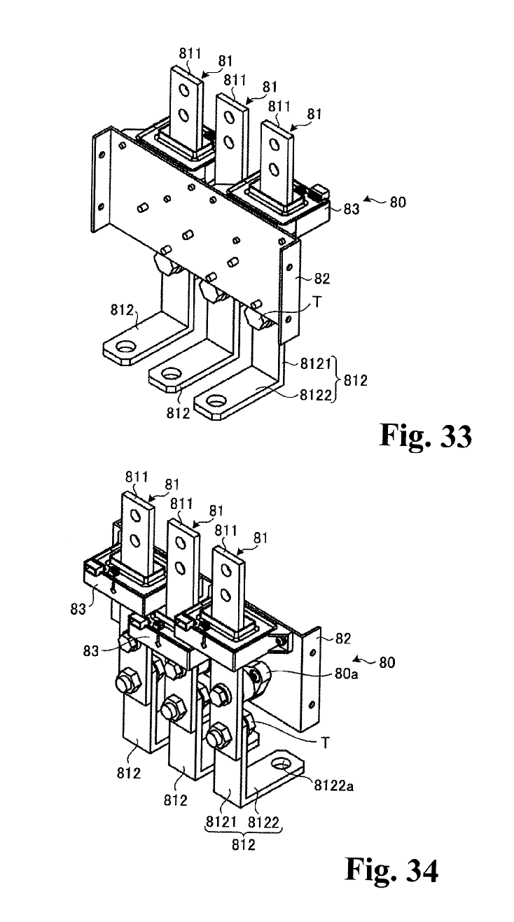

Each of FIG. 31 to FIG. 34 shows the first output relay unit 80, wherein FIG. 31 is a front view, FIG. 32 is a side view, FIG. 33 is a perspective view viewed. from the front, and FIG. 34 is a perspective view viewed from the rear.

The first output relay unit 80 illustrated here includes three output relay bars 81 and a fixing plate 82. The three output relay bars 81 are one that links the U-phase output terminal and the U-phase output relay terminal 53, one that links the V-phase output terminal and the V-phase output relay terminal 53, and one that links the W-phase output terminal and the W-phase output relay terminal 53.

The three output relay bars 81 include a first output relay bar 811 and second output relay bar 812. The first output relay bar 811 extends in a vertical direction, and an upper end portion thereof can be linked to the corresponding output terminal. The second output relay bar 812 has an L-shaped longitudinal section form, and more specifically, has a base portion 8121 and leading end portion 8122. The base portion 8121 extends in a vertical direction, and an upper end portion thereof is fastened via a fastening member T to a lower end portion of the first output relay bar 811. The leading end portion 8122 is a region extending forward from a lower end portion of the base portion 8121, and can be fastened via a fastening member T to the front surface end portion 532 of the corresponding output relay terminal 53. Further, an insertion hole (not shown) in the base portion 8121 through which the fastening member T is inserted, and an insertion hole 8122a in the leading end portion 8122 through which the fastening member T is inserted, are formed in the second output relay bar 812 so as to have a diameter larger than the outer diameter of the fastening member T.

The fixing plate 82 is configured by carrying out an appropriate bending process on sheet-metal, and is integrally linked with the three output relay bars 81 across resin 80a, which is an insulating member, thereby forming a unit. This kind of fixing plate 82 is for fixing in the inverter stack 10. Reference numeral 83 in FIGS. 31 to 34 is a Hall effect current transformer, and carries out current detection.

As this kind of first output relay unit 80 has the three output relay bars 81, the three phases of output from the output terminals can be output as they are to the output relay terminals 53.

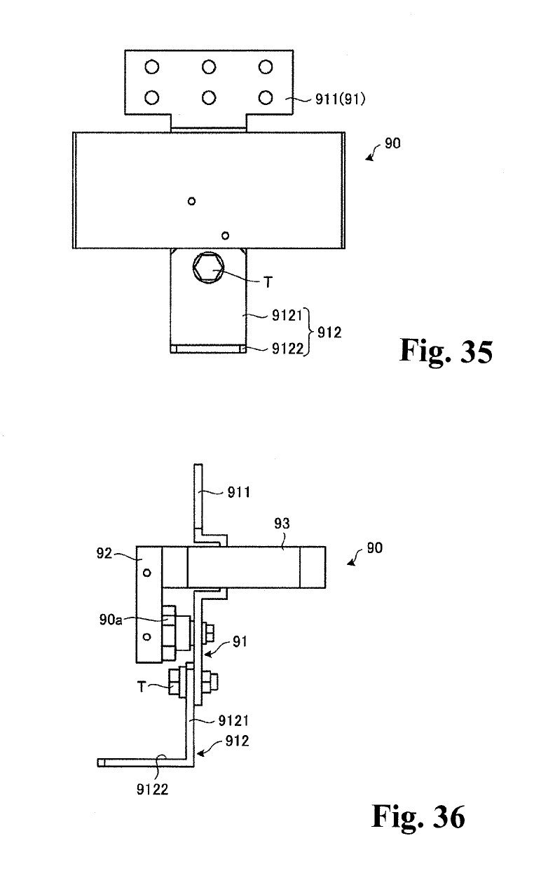

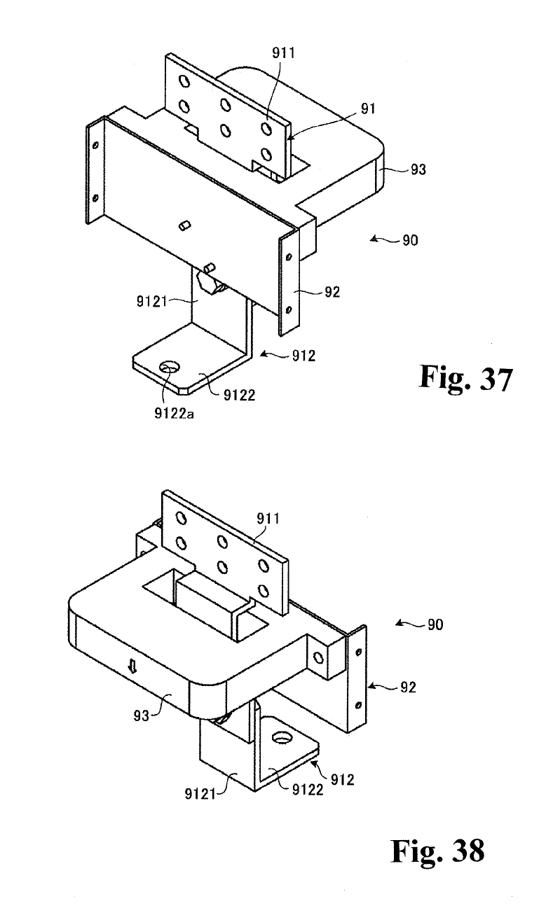

Each of FIG. 35 to FIG. 38 shows the second output relay unit 90, wherein FIG. 35 is a front view, FIG. 36 is a side view, FIG. 37 is a perspective view viewed from the front, and FIG. 38 is a perspective view seen from the rear.

The second output relay unit 90 illustrated here includes one output relay bar 91 and a fixing plate 92. The output relay bar 91 includes a first output relay bar 911 and second output relay bar 912. The first output relay bar 911 extends in a vertical direction, and an upper end portion thereof can be linked to the three output terminals.

The second output relay bar 912 has an L-shaped longitudinal section form, and more specifically, has a base portion 9121 and leading end portion 9122. The base portion 9121 extends in a vertical direction, and an upper end portion thereof is fastened via a fastening member T to a lower end portion of the first output relay bar 911. The leading end portion 9122 is a region extending forward from a lower end portion of the base portion 9121, and can be fastened via a fastening member T to the front surface end portion 532 of any output relay terminal 53. Further, an insertion hole (not shown) in the base portion 9121 through which the fastening member T is inserted, and an insertion hole 9122a in the leading end portion 9122 through which the fastening member T is inserted, are formed in the second output relay bar 912 so as to have a diameter larger than the outer diameter of the fastening member T.

The fixing plate 92 is configured by carrying out an appropriate bending process on sheet-metal, and is integrally linked with the output relay bar 91 across resin 90a, which is an insulating member, thereby forming a unit. This kind of fixing plate 92 is for fixing in the inverter stack 10. Reference numeral 93 in FIGS. 35 to 38 is a Hall effect current transformer, and carries out current detection.

As this kind of second output relay unit 90 has the one output relay bar 91, the three phases of output from the output terminals can be output to the output relay terminals 53 as a single phase, which is one of the U-phase, V-phase, or W-phase.

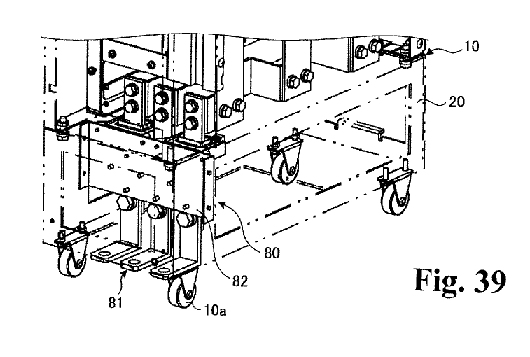

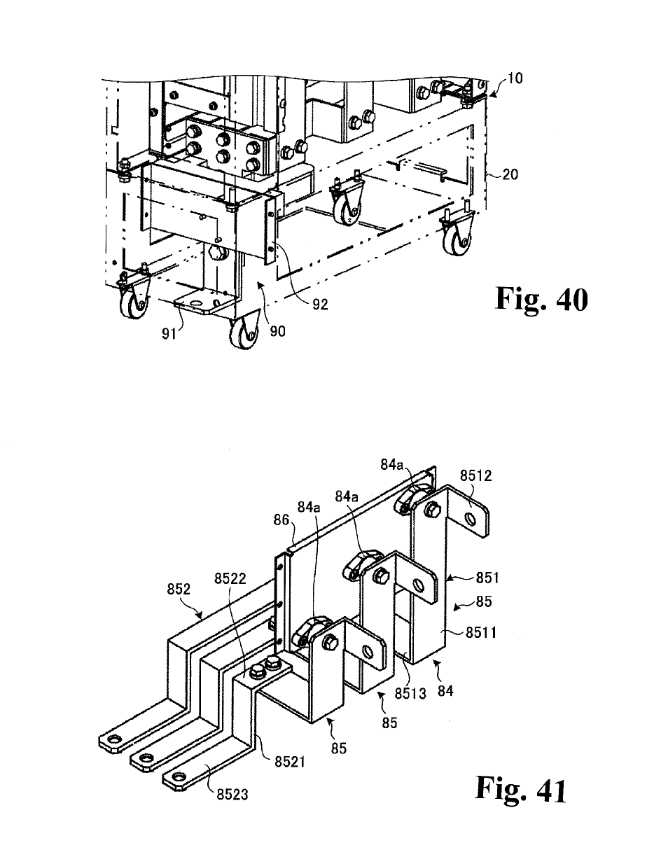

Further, the first output relay unit 80 may be used as the output relay unit by fixing it to the lower frame 20 of the inverter stack 10 via the fixing plate 82 and fastening the output relay bars 81 to the output terminals and output relay terminals 53, as shown in FIG. 39, or the second output relay unit 90 may be used as the output relay unit by fixing it to the lower frame 20 of the inverter stack 10 via the fixing plate 92 and fastening the output relay bar 91 to the output terminals and one of the output relay terminals 53, as shown in FIG. 40.

As heretofore described, the transport cart 1 is such that the support surface 3 that supports the inverter stack 10 in amounted condition has a height level the same as that of the inverter stack 10 mounting surfaces 51 in the switchboard 50 in which the inverter stack 10 is to be installed, and positioning in a horizontal direction is carried out by the protruding portion 3a provided so as to protrude outward from the support surface 3 entering the entrance portion 52 of the switchboard 50 formed between the mounting surfaces 51, because of which there is no need for high positioning accuracy, as there is with a heretofore used lifter. Moreover, there is no need for a mechanism, or the like, that moves a support stand in a vertical direction, as there is with a litter. Consequently, according to the transport cart 1, it is possible to more easily install the inverter stack 10 in the switchboard 50, while achieving a reduction in cost.

Also, according to the transport cart 1, the rail guides 4 disposed on the support surface 3 in the direction in which the inverter stack 10 can move restrict deviation in a horizontal direction with respect to the direction of movement when moving the inverter stack 10, because of which it is possible to carry out the inverter stack 10 installation work well.

Furthermore, according to the transport cart 1, the inverter stack 10 is fixed and supported by the fixing plate 5 standing upright from the support surface 3 being fastened via fastening members such as the screws N1 to the inverter stack 10 supported by the support surface 3, because of which it is possible to prevent the inverter stack 10 from falling even during transportation.

Further still, according to the transport cart 1, the gripping portions 6 are provided so as to form a horizontal pair on the base 2 including the support surface 3, because of which it is possible to transport the inverter stack 10 well, even in a narrow passage, or the like.

The inverter stack 10 is such that, when the bolt members 60 are tightened in a condition wherein the body portions 60a of the bolt members 60 are passed through the clamping hole portions 412 of the engagement holes 41, the fan block 40 is engaged with the inverter main body 30, while when the body portions 60a are passed through the attachment hole portions 411 of the engagement holes 41 by the tightening force of the bolt members 60 being released and the bolt members 60 being slid in a horizontal direction relative to the engagement holes 41, the fan block 40 is allowed to be disengaged from the inverter main body 30 by being pulled out to the front side, because of which it is possible to disengage the fan block 40 from the inverter main body 30 even when the width of the housing region in which the inverter stack 10 is installed is small, and thus possible to easily carry out the work of removing the fan block 40. In particular, according to the inverter stack 10, the stopper nuts 62 are fixed to the leading end portions 60b of the bolt members 60, because of which the bolt members 60 do not fall out even when the tightening force of the bolt members 60 is released. Consequently, it is possible to prevent the bolt members 60 from falling out when disengaging the fan block 40 from the inverter main body 30.

Also, according to the inverter stack 10, when the fan block 40 is disposed on the upper surface of the inverter main body 30, the protruding piece 321 of the inverter main body 30 is inserted through the latch hole 43 of the fan block 40, and furthermore, the rear extending portion 44 of the fan block 40 is held down by the plate spring member 322 attached to the inverter main body 30, because of which it is sufficient simply to push the fan block 40 in toward the rear, and thus possible to carry out the fan block 40 installation work well.

The heretofore described inverter device is such that the output relay terminals 53 are provided so as to extend in the inverter stack 10 entry direction in the housing bottom portion in which the inverter stack 10 is housed, the output wire 55 connected to a load such as a motor is attached to the rear surface end portion 531, and the front surface end portion 532 is linked to the output terminal of the inverter stack 10 and fastened via the fastening member T to the output relay bar 73 protruding downward from the bottom portion of the inverter stack 10, because of which it is possible to release the output side connection condition of the inverter stack 10 and switchboard 50 simply by releasing the fastenings of the output relay terminals 53 and output relay bars 73. Consequently, according to the inverter device, it is possible to easily remove the inverter stack 10 from the switchboard 50.

Also, according to the inverter device, the input relay bar 70 is such that, as the fastening members T, such as bolts, are inserted through the hole portions 71 in which are formed the cutouts 72 communicating with the same side portion, it is possible to disengage the input relay bar 70, without removing the fastening members T, by releasing the tightening force of the fastening members T, and thus possible to release the input side connection condition of the inverter stack 10 and switchboard 50. Consequently, for this reason too, it is possible to easily remove the inverter stack 10 from the switchboard 50.

Furthermore, according to the inverter device, the lower frame 20 configuring the inverter stack 10 is such that, as the frame members 21 configuring one side of the four-sided frame through which the output relay bar 73 passes are formed of a non-magnetic body, it is possible to control the occurrence of an overcurrent, because of which it is possible to prevent heating and vibration due to the occurrence of an overcurrent, or the like. Also, as the other frame members 21 of the lower frame 20 are configured of sheet-metal or the like, it is possible to reduce manufacturing cost in comparison with when forming all the frame members of a non-magnetic body such as stainless steel. Consequently, it is possible to achieve a reduction in manufacturing cost while preventing heating and vibration due to the occurrence of an overcurrent, or the like. Provided that it is clear that no overcurrent due to the magnitude of the current transmitted through the output relay bar 73 will occur in the lower frame 20, the frame members 21 formed of a non-magnetic body may be replaced with frame members formed of a magnetic body such as sheet-metal. When it is clear in this way that no overcurrent will occur, it is possible to achieve a reduction in operational cost by configuring all the frame members 21 configuring the lower frame 20 of a magnetic body.

Further still, according to the inverter device, it is possible to use an output relay unit alternatively selected from the first output relay unit 80 and second output relay unit 90 as the output relay unit instead of the output relay bar 73, because of which it is possible to easily carry out a change in the output terminal configuration linking the inverter stack 10 and switchboard 50.

Heretofore, a description has been given of a preferred embodiment of the invention but, the invention not being limited to this, various changes can be carried out.

In the heretofore described embodiment, an output relay unit alternatively selected from the first output relay unit 80 and second output relay unit 90 is used as the output relay unit, but the invention is such that an output relay unit having the following kind of attachment member 84 may be used as a modification example of the first output relay unit 80.

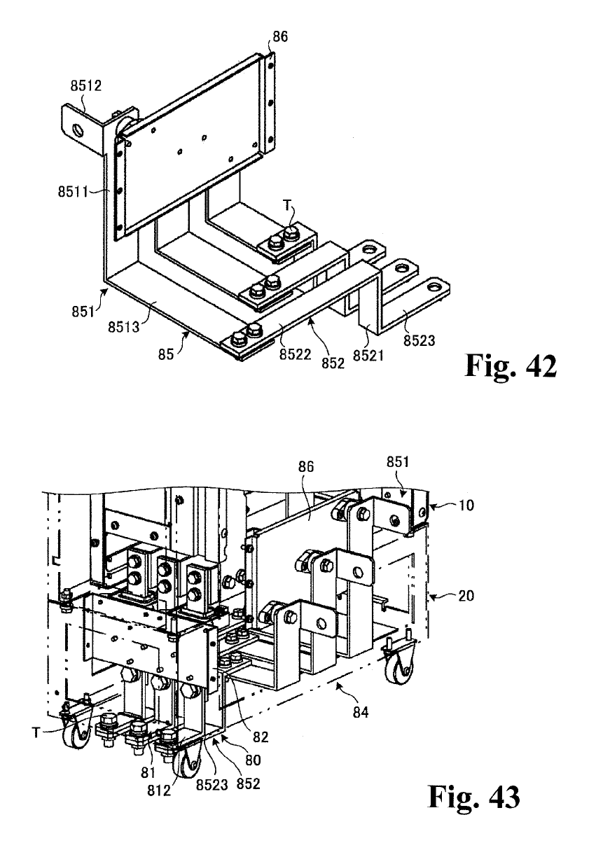

Each of FIG. 41 and FIG. 42 shows the attachment member 84, which is applicable to the first output relay unit 80 shown in FIG. 31 to FIG. 34, wherein FIG. 41 is a perspective view seen from the front, while FIG. 42 is a perspective view seen from the rear. The attachment member 84 illustrated here includes three output relay attachment bars 85.

The three output relay attachment bars 85 include a first output relay attachment bar 851 and second output relay attachment bar 852. The first output relay attachment bar 851 is formed to have a first base portion 8511 extending in a vertical direction, a right extending portion 8512 extending rightward from an upper end portion of the first base portion 8511, and a left extending portion 8513 extending leftward from a lower end portion of the first base portion 8511, wherein the first base portion 8511 is linked to an attachment fixing plate 86 across resin 84a, which is an insulating member.

The second output relay attachment bar 852 is formed to have a second base portion 8521 extending in a vertical direction, a rear extending portion 8522 extending backward from an upper end portion of the second base portion 8521, and a front extending portion 8523 extending forward from a lower end portion of the second base portion 8521, wherein the rear extending portion 8522 is fastened via a fastening member T to the left extending portion 8513 of the first output relay attachment bar 851.

This kind of attachment member 84 is used by fixing the attachment fixing plate 86 to the lower frame 20 of the inverter stack 10 and fastening the front extending portion 8523 of each second output relay attachment bar 852 to the leading end portion 8122 of the corresponding second output relay bar 812 via a fastening member T, as shown in FIG. 43.

By using the first output relay unit 80 including this kind of attachment member 84 as the output relay unit, it is possible to respond flexibly to customer demands and specification changes.

### REFERENCE SIGNS LIST

1 Transport cart

1a Cart caster

2 Base

3 Support surface

3a Protruding portion

4 Rail guide (guide member)

5 Fixing plate (fixing and supporting member)

5a Screw holes

7 Gripping portion

10 Inverter stack

10a Caster

20 Lower frame

21 Frame member

30 Inverter main body

31 Aperture

32 Rear edge portion

321 Protruding piece

322 Plate spring member

322a Leading end portion

323 Through hole

33 Upper front surface

331 Slot

34 Upper side edge portion

35 Input terminal

40 Fan block

40a Lower surface aperture

41 Engagement hole

411 Attachment hole portion

412 Clamping hole portion

42 Flange

43 Latch hole

44 Rear extending portion

50 Switchboard

51 Mounting surface

52 Entrance portion

53 Output relay terminal

531 Rear surface end portion

532 Front surface end portion

532a Through hole

532b Nut

54 Insulator

55 Output wire

56 Input side terminal

60 Bolt member

60a Body portion

60b Leading end portion

60c Head portion

61 Plate member

611 Through hole

612 Nut

62 Stopper nut

70 Input relay bar

71 Hole portion

72 Cutout

73 Output relay bar

731 First output relay bar

732 Second output relay bar

7321 Base portion

7322 Leading end portion

7321a Insertion hole

7322a Insertion hole

80 First output relay unit

81 Output relay bar

80a Resin

811 First output relay bar

812 Second output relay bar

8121 Base portion

8122 Leading end portion

8122a Insertion hole

82 Fixing plate

84 Attachment member

84a Resin

85 Output relay attachment bar

851 First output relay attachment bar

8511 First base portion

8512 Right extending portion

8513 Left extending portion

852 Second output relay attachment bar

8521 Second base portion

8522 Rear extending portion

8523 Front extending portion

86 Attachment fixing plate

90 Second output relay unit

90a Resin

91 Output relay bar

911 First output relay bar

912 Second output relay bar

9121 Base portion

9122 Leading end portion

9122a Insertion hole

92 Fixing plate

F Fan

T Fastening member

What is claimed is:

1. An inverter device, comprising:
an inverter stack; and
a switchboard to insert the inverter stack from a front side thereof to store,
wherein the inverter stack, as an output relay unit, linking three phase output terminals of the inverter stack and output relay terminals forming the switchboard and attached with output wires connected to a load, alternatively selects
a first output relay unit wherein three phase output relay bars capable of directly outputting three phase outputs from the output terminals to the output relay terminals and a fixing plate to fix the three phase output relay bars to the inverter stack are unitized through an insulating member, or
a second output relay unit wherein a single-phase output relay bar capable of outputting three phase outputs from the output terminals as a single phase to the output relay terminals and a fixing plate to fix the single-phase output relay bar to the inverter stack are unitized through an insulating member.

2. The inverter device according to claim 1, wherein the output relay terminals are provided to extend along an entering direction of the inverter stack in a housing bottom portion housing the inverter stack,
the three phase output relay bars configuring the first output relay unit, each comprising
a first three-phase output relay bar extending in a vertical direction, and having an upper end portion capable of connecting to the output terminal, and
a second three-phase output relay bar having a base portion extending in a vertical direction and a leading end portion extending in the entering direction of the inverter stack from a lower end of the base portion, wherein the base portion is fastened to a lower end portion of the first three-phase output relay bar through a fastening member and the leading end portion is capable of being fastened to the output relay terminal through a fastening member,
the single-phase output relay bar configuring the second output relay unit comprising
a first single-phase output relay bar extending in a vertical direction and having an upper end portion capable of connecting to the output terminal, and
a second single-phase output relay bar having a base portion extending in the vertical direction and a leading end portion extending in the entering direction of the inverter stack from a lower end of the base portion, wherein the base portion is fastened to a lower end portion of the first single-phase output relay bar through a fastening member and the leading end portion is capable of being fastened to the output relay terminal through a fastening member, and
the second three-phase output relay bar and the second single-phase output relay bar having insertion holes to insert the fastening member with a diameter larger than an external diameter of the fastening member.
